(19) United States
(12) Patent Application Publication
(10) Pub. No.: US 2026/0274398 A1
(43) Pub. Date: Sep. 17, 2026

(54) AERONAUTICAL PROPULSION UNIT WITH IMPROVED ACOUSTICS

(71) Applicant: SAFRAN AIRCRAFT ENGINES, PARIS (FR)

(72) Inventors: Nicolas Alexandre BOUSSAT, MOISSY-CRAMAYEL (FR); Fernando GEA AGUILERA, MOISSY-CRAMAYEL (FR)

(21) Appl. No.: 19/474,590

(22) PCT Filed: Apr. 12, 2024
(86) PCT No.: PCT/FR2024/050489

§ 371 Date: Oct. 10, 2025

(30) Foreign Application Priority Data
Apr. 13, 2023 (FR) FR2303723

(51) Int. Cl. B64C 11/18; B64D 27/10; F01D 17/16

(52) U.S. Cl. CPC B64C 11/18; B64D 27/10; F01D 17/16; B64C 2220/00

(57) ABSTRACT

An aeronautical propulsion unit having a longitudinal axis and an upstream rotor row and a downstream stator row of unducted blades. In the downstream state row, at least two stator blades are at different axial positions relative to one another along the longitudinal axis of the propulsion unit.

### TECHNICAL FIELD

This disclosure relates to the field of aeronautical propulsion units.

It concerns aeronautical propulsion units which each have a longitudinal axis (X hereinafter) and comprise:
spaced apart from one another along said longitudinal axis (X):
   a plurality of unducted rotor blades, mounted to rotate about the longitudinal axis (X) and about a hub of the propulsion unit, and
   a plurality of stator blades (or guide vanes), fixedly mounted about the longitudinal axis (X) and about a casing (also called an engine casing) of the propulsion unit, downstream of the rotor blades in the direction of the flow of gases from upstream to downstream along the propulsion unit, the stator blades being unducted, the rotor blades and stator blades each having a free radially outer end which is radially further from the casing (13) than a radially inner end.

In accordance with the foregoing and the following, throughout the text, the relative terms “upstream” and “downstream” are defined, relative to each other, in reference to the flow of gas, which may be during the cruising flight phase, along the propulsion unit (around and/or within it) in the longitudinal direction (i.e. the direction of the longitudinal axis).

The aeronautical propulsion unit may comprise (at least) a heat engine, in particular a turbine engine, turboshaft engine, turbojet, turbofan, and/or (at least) an electric motor, and/or (at least) a hydrogen engine, and/or (at least) a hybrid engine: heat and/or electric and/or hydrogen. The engine(s) may be used to drive the rotor blades; in particular to allow a variable pitch of the stator blades and/or rotor blades (variable angle vanes or variable angle rotor blades or variable pitch vanes/blades) around the respective axes along which said blades individually extend.

### PRIOR ART

Reference will be made hereinafter more particularly, and therefore without limitation, to the case of turbine engines, since the type(s) of engine included in the propulsion unit is not a determinant here. Turbine engine is understood to mean a propulsion unit in which there is an exchange of energy between a flowing fluid and a rotor (also called a propeller) comprising said plurality of rotor blades.

In this context, recall as an example that a turbine engine with an “unducted” fan (or a turboprop of the type known as a “Propfan” or “Open Fan” or “Open Rotor” or “Unducted Single Fan”—USF —or “Counter-Rotating Open Rotor”) is a type of turbine engine in which the fan extends outside the engine casing (or nacelle), unlike conventional turbine engines (“turbofans”) in which the fan is ducted.

In the case of unducted turbine engines, the absence of a duct leads to an increase in the noise level emitted by the aeronautical propulsion units, which typically comprise at least one row of upstream rotor blades that interact with the blades of at least one row of downstream stator blades.

Indeed, the noise generated by the annular rows of unducted blades propagates in a free field. One of the main causes of the emitted noise is related to vortex structures generated in the airflow at the free radially outer tips of the rotor blades. These blade tip vortices can interact with the blades of the downstream stator row(s).

One of the challenges of these architectures is certification for the noise levels during takeoff and landing operations. The noise levels emitted by aircraft are subject to increasingly strict regulations.

“Row” (of blade(s)) is understood to mean at least one blade for which the reference axis (along which the blade extends) is located at a determined axial position relative to a given axial reference. Around the longitudinal axis:
for the stator blade(s), a “row of blade(s)” comprises one or more blades, and
for the rotor blade(s), a “row of blade(s)” comprises several blades.

Thus, a row of stator blade(s) is located at a determined axial position (X axis) relative to the upstream plane where the reference axes of the rotor blades are located, these axes advantageously all being located in a same plane perpendicular to the longitudinal axis.

“Reference axes” is understood to mean blade axes:
either for adapting a pitch angle of two successive blades, when these axes are projected in a plane perpendicular to the longitudinal axis (X) and if said two successive blades (i.e. adjacent around the X axis) have a variable pitch angle,
or transverse to the longitudinal axis (X) and passing through:
   the radially inner ends or the radially outer ends of said two successive blades, or
   through their centers of gravity, respectively,
if said two successive blades have a fixed pitch angle;
or, for one of said respective axes, for adapting a pitch angle of one of said two successive blades, when the blade has a variable pitch angle, and for the other, transverse to the longitudinal axis (X) and/or passing through the radially inner end or the radially outer end or the center of gravity of the adjacent blade, when the blade has a fixed pitch angle.

“Transverse” is understood to mean inclined relative to the longitudinal axis (X), but not necessarily perpendicular to this X axis.

“Axially” means: along or parallel to the longitudinal axis (X).

The main sources of noise in unducted turbine engines are listed below:
noise from interactions between the vortex generated at the blade tips and the rotor wake, if the rotor is followed downstream by a stator, the upstream rotor interacting with the leading edge of the blades of the downstream stator. This noise source contributes to the increase in:
   broadband noise, as the turbulence rate is often very high in the blade tip vortex and in the blade wake,
   tonal noise, linked to the periodic nature of the upstream rotor wake and of the vortex during rotor blade rotations,
blade noise due to the stationary load of the blades (source of tonal noise in a rotor) and the development of the boundary layer on the blades (rotor or stator); thus, the source of broadband noise is generated during the passage through the turbulent boundary layer at the trailing edge of the blades; the increase in the blade chord in unducted turbine engines increases the surface area over which the boundary layer develops.

It should be noted that the absence of a nacelle on unducted turbine engines implies a significant reduction in surface areas having acoustic treatments (honeycomb-type resonators, absorbent materials, in particular porous materials, etc.), and therefore in means which allow reducing noise.

Furthermore, when a rotor is subjected to a non-uniform flow upstream that is not parallel to the engine axis—the aforementioned longitudinal axis—(flight at greater angle of attack, with crosswind, or effects from installation), forces and moments appear in the propeller plane, called 1P forces.

When flying at a greater angle of attack, not only does an upstream rotor followed by at least one downstream stator provide a tractive force in the horizontal axis for forward movement of the aircraft (this is not necessarily the longitudinal axis (axis of the engine/aeronautical propulsion unit); it is the horizontal direction of forward movement). For example, when the aeronautical propulsion unit is installed under a wing, and/or the propulsion unit is oriented at a certain angle of incidence relative to the upstream flow, a descending rotor blade sees an increase in angle of attack and is therefore subjected to increased forces, unlike an ascending blade on which reduced forces are exerted. As a result, over one revolution of the engine, the same rotor blade is subjected to variable forces that depend on its azimuthal position, i.e. around the longitudinal axis.

Stator blades located downstream will therefore also have a variable load depending on their azimuthal position. As they are axially opposite the upstream rotor blades, if, at the position of a given stator blade, the angle of attack seen by the blade is somewhat significant, the stator blades axially opposite the descending rotor blades will be less loaded and will have less twist to correct, while the stator blades axially opposite the ascending rotor blades will be more loaded and will have more twist to correct.

It should also be noted that the upstream angle of attack a (aircraft angle of attack) is not completely filtered by the upstream rotor. In addition to the variation in 1P forces, the stator blades will be subjected to different angles of attack, due to the aircraft angles of attack and the frequent presence of a paired pylon (or equivalent)/wing, depending on their azimuthal position.

Some of the aforementioned noise sources can be attenuated at the source, i.e. by designing blades with a design that takes into account aerodynamic, mechanical, and acoustic constraints, and/or by optimizing the blade pitch and/or the azimuthal distance between the blades of the same wheel (propeller or stator) and/or by modifying the cycle parameters (rotation speed, target thrust, etc.).

However, the placement of unducted rotor/stator blades at certain (at least) axial, or even azimuthal, positions may depend on several factors:
the advantages for or the impact on the aerodynamics, mechanics, performance, and acoustics, among others. Indeed, the position of a blade may be the result of a compromise or a multi-disciplinary optimization. Regarding noise reduction, the azimuthal position of the downstream stator blade(s) (of a USF for example; or “clocking”) makes it possible to vary the directivity of the sound in free-field conditions, i.e. on noise that is directed towards the passenger cabin or towards the ground. Furthermore, the greater the axial distance between the upstream propeller and the downstream stator, the more the interaction noise is reduced, because the wakes of the upstream propeller (partly) dissipate as they propagate towards the leading edge of the downstream stator blade(s),
the shape of the hub/gas flow path around the blades, and the bulk due to the integration of certain systems and/or devices within the hub/nacelle under the blades, which must allow the integration of the blade pitch change system, elements of the regulation system (air ducts/pipes, oil, ancillaries, exchangers, etc.), structural arms, strut attachment, etc., all within a reduced footprint and while ensuring that the shape of the bypass flow path is satisfactory from an aerodynamic point of view and provides good performance (low losses and drag, etc.),
the installation of the aeronautical propulsion unit on the aircraft (under/on the wing, towards the rear of the aircraft fuselage, etc.), and the elements close to the aeronautical propulsion unit: strut/pylon, wing, slat, flaps, stabilizers, fuselage, etc.; for example:
   the presence of the wing pylon downstream and potentially between stators may have the impact of making it impossible to control the pitch of stators located facing and/or on either side of the pylon,
   the presence of the wing pylon may also prevent axially offsetting one or more downstream stator blades, or
   the relative position of the blades in the aeronautical propulsion unit: for example, rotor-rotor/stator upstream (“puller” configuration) or rotor-rotor/stator downstream (“pusher” configuration).

The present description aims to take these problems at least partially into account, and to propose a solution.

### SUMMARY

At this point, let us immediately specify that, although the above prior art relates to a turbine engine, the solution of the invention applies to any aeronautical propulsion unit that is unducted and/or of the “Open Rotor” or “Open Fan” type, since part of the aforementioned problem is not necessarily specific to a turbine engine.

In this context, and in general, an aeronautical propulsion unit is therefore proposed here which has a longitudinal axis (X) and comprises:
spaced apart from one another along said longitudinal axis:
   a plurality of unducted rotor blades, mounted to rotate about the longitudinal axis and about a hub of the propulsion unit, and
   a plurality of stator blades, fixedly mounted about the longitudinal axis and about a casing of the propulsion unit, downstream of the rotor blades in the direction of the flow of gases from upstream to downstream along the propulsion unit, the stator blades being unducted, two adjacent (therefore/or successive) stator blades around the longitudinal axis having an azimuthal angular spacing between them that is defined by the angle between the respective reference axes:
      either for adapting a pitch angle of said two successive stator blades, when these axes are projected in a plane perpendicular to the longitudinal axis and if said two successive blades have a variable pitch angle,
      or transverse to the longitudinal axis and passing through the radially inner ends or the radially outer ends of said two successive stator blades or through their centers of gravity, respectively, if said two successive blades have a fixed pitch angle,
      or, for one of said respective axes, for adapting a pitch angle of one of said two successive stator blades, when the blade has a variable pitch angle, and for the other, transverse to the longitudinal axis and/or passing through the radially inner end or the radially outer end or through the center of gravity of said adjacent blade, when the blade has a fixed pitch angle,
the rotor and stator blades each having a free radially outer end that is radially further from the casing than a radially inner end, the propulsion unit being characterized in that:
   along the longitudinal axis, at least two stator blades are at different axial positions from one another, and
   for each pair of two stator blades, the ratio between the maximum chord of said two blades is between 0.8 and 1.25, preferably between 0.9 and 1.11, the maximum chord being measured on a radial cross-section of the stator blade.

The term “on a radial cross-section” refers to a given radial position of the blade height.

In particular, at least two stator blades may be identical.

“At least two stator blades being identical” is understood to mean that at least two stator blades have the same geometry, i.e. the same three-dimensional shape and structure.

In other words, the at least two stator blades are “identical” if they have a reference axis defined geometrically in the same manner.

In particular, at least two stator blades having the same axial position may be identical. These said at least two blades belong to a same row of stator blades.

According to the invention, the positioning of the stator blades at different axial positions from one another makes it possible to:
locally increase the distance between the upstream rotor blades and the downstream stator blades, which makes it possible to improve the mixing and dissipation of the rotor blade wakes which interact with the leading edges of the stator blades, thus making it possible to reduce noise from interactions,
introduce a de-correlation of acoustic sources, i.e. allow not exciting all these sources at the same time and thus reducing the efficiency of the acoustic radiation forces by creating interference,
take into account the installation of the aeronautical propulsion unit on the aircraft (under-wing, at the rear, etc.), which can reduce, over a circular sector in the azimuthal direction (for example, at the suspension pylon or strut) the maximum distance between the unducted stator blades and rotor blades.

Regarding the “azimuthal angular spacing”, this can be defined, in a manner equivalent to the above, by the angle between the following respective axes:
blade pitch change axes, if these axes are perpendicular to the longitudinal axis (X),
if the pitch change axis is inclined (not perpendicular to the longitudinal axis), the axial position of the row of blade(s) concerned can be defined at the intersection of the pitch change axis and the hub/casing/nacelle, i.e. at the blade root cross-section, and
if at least one of the blades has a fixed pitch, the axial position of the row of blade(s) can be measured relative to a point located at mid-chord (midway between the leading edge and the trailing edge of the blade) at the blade root cross-section.

It is also proposed that, between their respective radially outer and radially inner free ends, the shortest rotor blade has a greater span than the longest stator blade, which ensures a weak interaction between the blade tip wake of the rotors and the downstream stator blades.

All the pressure-side faces of the stator blades are preferably oriented in a same circumferential direction around the longitudinal axis. To this end, the stator blades will therefore have a non-symmetrical profile and will have a face referred to as the pressure-side face and a face referred to as the suction-side face.

To optimize the aerodynamic operation of the stator blades, it is also proposed that the stator blades located furthest downstream have a mean chord along their span and/or a chord distribution (or law) along their span that differs from those located furthest upstream.

It is also proposed that the mean chord of the stator blades decreases axially from upstream to downstream. This should reduce the volume occupied by the stator wheel and facilitate its installation. For example, this would prevent the stator blades furthest downstream from being impacted by potential installation-related effects, such as a local increase in pressure at the leading edge of the pylon and/or wing, which would lead to a variation in the pressure field on the upstream and/or nearby stators.

To account for the presence of a primary flow with a separator between the rotor blades and stator blades, which has the effect of raising the stator blades in the radial direction, it is also proposed that:
the stator blades and the rotor blades each have a minimum radius, measured between the radially inner end of the blade and the longitudinal axis (X), and
the minimum radius of any rotor blade is less than the minimum radius of any stator blade.

In order to limit the impact of vortices formed at the radially outer end of the upstream rotor blades on the downstream stator blades, it is proposed that:
the radially outer(most) end of each rotor blade is inscribed within a first circle and the radially outer(most) end of each stator blade is inscribed within a second circle, the radius of the second circle being less than the radius of the first circle, the radii being centered on the same axis. The advantage here is to reduce the impact of blade tip vortices from the rotors on the stator blades, in order to reduce noise from interactions. Indeed, at high speed, the stream tube from the propeller will contract and move closer to the radially outer ends of the stator, which justifies reducing their span.

For the following reasons, it is also proposed that at least one of the following features a) to c) be implemented:
a) there are, around the longitudinal axis, several reference axes of stator blades, located at a same axial distance from the reference axes of several rotor blades, and the radially outer end of each rotor blade is inscribed within a primary circle and the radially outer end of certain stator blades is inscribed within a first secondary circle and the radially outer end of certain stator blades is inscribed within a second secondary circle, the radii of the secondary circles being less than the radius of the primary circle, said radii being centered on the same axis, and the radii of the secondary circles decreasing in the downstream direction. In this configuration, the radially outer tips of the upstream stator blades are located radially externally relative to the radially outer tips of the downstream stator blades, which reduces acoustic emissions due to the interaction of the blade tip vortices of the rotors with the stator blades.
b) the blades located furthest downstream have a different mean chord and/or chord distribution along the span than those located further upstream, the mean chord of the stator blades preferably decreasing on a stator blade located further downstream in comparison to a stator blade located further upstream,
c) with at least some of the stator blades having said respective reference axes for adapting a pitch angle, at least some of the pitches of the stator blades located further upstream are different from at least some of the pitches of the stator blades located further downstream.

The variation in the level of “clipping”, according to feature a) (clipping/truncation consisting of reducing the diameter of the blades of one row relative to those of another row) is explained by the fact that the rotor tip vortex moves closer to the hub/casing as it progresses downstream due to the contraction of the streamlines downstream of the rotor. Thus, increasing the distance between the upstream rotor and the downstream stator may usefully be supplemented by increasing the “clipping” of the stator vanes furthest downstream in order to avoid interaction with the rotor blade tip vortices upstream.

A variation in the chord of the profile according to feature b) may allow the blades located furthest downstream to have a different mean chord and/or chord distribution (along the span) than those located (further) upstream. Preferably, the mean chord of the stator blades will then decrease in the row(s) located (further) downstream. Indeed, this should reduce the size of the stator wheel and facilitate its installation. For example, this would prevent the most downstream stator blades from being contaminated by potential updrafts from an element (such as a pylon) attaching the propulsion unit to an aircraft or from a wing of that aircraft.

A modification of the blade pitch, in order to best adapt to the incident flow and take installation effects into account (presence of a pylon and/or equipment on the propulsion unit, influence of the aircraft fuselage, etc.). In particular, for a given operating point of the propulsion unit, the pitch of the upstream stator blades may differ from the pitch of the downstream stator blades.

It should be noted that stator blades in a same row and/or located at the same axial position may have different pitches, particularly on either side of the pylon (to optimize aerodynamic performance, for example, to avoid the occurrence of shocks while cruising, which would increase losses).

To avoid any impact from the propeller/rotor tip vortex (vortex-blade interaction is a zero-order mechanism affecting the noise emitted by the rotor-stator pair), a notable geometric modification aimed at reducing noise consists of reducing the outer radius of the stator (stator blades) so that there is a geometric clipping defined as follows:

$$\frac{{Re}_{h} - {Re}_{s}}{{Re}_{h} - R {i}_{h}} ,$$

with:
Reₕ and Reₛ being the radii of the respective free radially outer tips of the rotor blades and stator blades, respectively, and,
Riₕ being the radius of the radially inner ends of the rotor blades, the geometric clipping value (in %) representing the reduction in height (span) of the downstream stator blades relative to the upstream rotor blades, and,
if the rotor blades have different free radially outer end radii between them, Reₕ is then defined by the smallest of the radii of the respective free radially outer ends of all the rotor blades,
and
the values of said geometric clipping are between −10% and +30%, depending on the azimuthal and axial position of the stator blade in question, preferably between 5% and 20%.

According to another feature, the axial distance between one of said respective reference axes of the rotor blades and one of said respective reference axes of the stator blades varies angularly. When the reference axes of the rotor blades are all placed in a same plane perpendicular to the longitudinal axis, it is understood that there are at least two stator blades that are axially offset from each other.

The leading edges of the stator vanes may be positioned axially and circumferentially so as to form a succession of convex and/or concave patterns.

Said respective reference axes of the stator blades may be arranged in several stator rows, each perpendicular to the longitudinal axis, each comprising one or more stator blades, wherein:
parallel to the longitudinal axis, two axially successive stator rows have between them an axial distance (Tⱼ), (Tⱼ)_{1≤j≤N-1}, where Tⱼ denotes the axial distance between the rows of stator blades j and j+1, and
in the case where there are at least three stator rows, the axial distances (Tⱼ) vary according to the stator rows in question.

According to one particular feature of the invention:
said respective reference axes of the stator blades are arranged in several stator rows, each perpendicular to the longitudinal axis (X), each comprising one or more stator blades,
with S being the smallest axial distance between said respective reference axes of one of the rotor blades and one of the stator blades of two stator rows, there exists a sequence (Tⱼ)_{1≤j≤N-1}, where Tⱼ denotes the axial distance between two axially successive stator rows, j and j+1, such that S≥max{Tⱼ} with 1≤j≤N−1, N being the number of stator rows.

This makes it possible to limit the axial spacing of the stator blade rows with regards to their spacing relative to the rotor blades, thereby limiting the axial length and weight of the aeronautical propulsion unit.

According to yet another feature:
the reference axes of the rotor blades are all located in a same plane perpendicular to the longitudinal axis, in a single rotor row of rotor blades,
said respective reference axes of the stator blades are arranged in several stator rows, each perpendicular to the longitudinal axis (X), each comprising one or more stator blades, and

$$1 \leq \frac{{max}_{j} \{ {T}_{j} \}}{{min}_{j} \{ {T}_{j} \}} \leq 10 ,$$

or preferably

$$1 \leq \frac{max \{ {T}_{j} \}}{min \{ {T}_{j} \}} \leq 4 ,$$

where Tⱼ denotes the axial distance between two axially successive stator rows, j and j+1, with 1≤j≤N−1, N being the number of stator rows and j=1 corresponding to the row of stator blades closest to the rotor row.

This makes it possible to limit the axial spacing of the stator blade rows and therefore the axial length and weight of the aeronautical propulsion unit.

In one particular embodiment, all the axial distances between the rows of stator blades are identical, i.e. T₁=T₂=T3, . . . . Expressed more generally, Tⱼ=Tⱼ₊₁.

According to another feature:
said respective reference axes of the stator blades are arranged in one or more stator rows, each perpendicular to the longitudinal axis (X), each comprising several stator blades,
with Reₛ corresponding to the maximum radius of a stator blade measured relative to the longitudinal axis (X), said maximum radius is defined for each stator row as follows: (Re_{s,j})_{1≤j≤N}, where Re_{s,1}, Re_{s,2}, Re_{s,3} . . . corresponds to the maximum radii of the blades in each stator row, with

$$0 \leq \frac{{max}_{j} \{ R {e}_{s , j} \} - {min}_{k} \{ R {e}_{s , k} \}}{R {e}_{h} - {Ri}_{h}} \leq 0.3 ,$$

or preferably:

$$0.01 \leq \frac{{max}_{j} \{ R {e}_{s , j} \} - {min}_{k} \{ R {e}_{s , k} \}}{R {e}_{h} - R {i}_{h}} \leq 0.2 ,$$

and k=1, . . . , N when j≠k, N being a natural number corresponding to the number of stator rows.

This configuration makes it possible to avoid weight differences between blades, which could make it difficult to balance the aeronautical propulsion unit.

It is possible that:
said respective reference axes of the stator blades are arranged in several stator rows, each perpendicular to the longitudinal axis (X), each comprising several stator blades,
with Reₛ corresponding to the maximum radius of a stator row blade measured relative to the longitudinal axis (X):
   said maximum radius is defined for each stator row as follows: (Re_{s,j})_{1≤j≤N}, where Re_{s,1}, Re_{s,2}, Re_{s,3} . . . correspond to the maximum radii of the blades of each stator row,
all the radii of blades of the same stator row are identical, and
Re_{s,1}≤Re_{s,2}≤Re_{s,3} . . . , meaning that the maximum radii of the blades of the stator rows decrease in the downstream direction.

Thus, the maximum radii of the stator rows decrease in the downstream direction to account for the downstream contraction of the stream tube. This simplifies the design of the stator row blades, which could be identical for each row.

However, it is possible for the stator blades in a same row to have a variable radial dimension or radius, leading to 360° clipping in order to prevent the interaction of the propeller blade tip vortex with certain stators during phases at a greater angle of attack. “360° clipping” is understood to mean that, within a same row, there are stator blades with different clipping (or truncation) depending on their azimuthal position, i.e. with different stator blade heights. This can be useful for limiting the vortex/stator blade interaction during phases at a greater angle of attack, in which some stator blades are more exposed to the impact of vortices than others.

According to another feature:
said respective reference axes of the stator blades are arranged in one or more stator rows, each perpendicular to the longitudinal axis, each comprising several stator blades, and
the blades of the stator row or of a same stator row have radii, each measured between the radially outermost end of each blade and the longitudinal axis, which vary from one blade to another.

It is also possible that:
said respective reference axes of the stator blades are arranged in one or more stator rows, each perpendicular to the longitudinal axis, each comprising several stator blades, and
with Riₛ corresponding to the minimum radius of the blades in a same stator row, measured relative to the longitudinal axis, said minimum radius:
   is defined for the or each stator row as follows: (Ri_{s,j})_{1≤j≤N} where Ri_{s,1}, Ri_{s,2}, Ri_{s,3} . . . correspond to the minimum radii of the blades of each stator row, and
   is different between the stator rows further upstream and those further downstream, meaning that Ri_{s,1}≠Ri_{s,2}≈Ri_{s,3}≈ . . .

In this configuration, the casing will not be in the form of a cylinder, i.e. having a constant radius at the stator blades.

According to another feature of the invention:
said respective reference axes of the stator blades are arranged in one or more stator rows, each perpendicular to the longitudinal axis (X), each comprising several stator blades, and
there exists a sequence

$${( Δ {θ}_{j , k} )}_{\begin{matrix}1 \leq j \leq N \\ 1 \leq k \leq {B}_{j}\end{matrix}} ,$$

where Δθ_{j,k} denotes the k-th azimuthal angular spacing in the j-th row of stator blades, and
for the set of stator blades of the j-th row, said azimuthal angular spacing may be uniform, meaning that there is only one azimuthal spacing Δθ_{j,1}, which is identical between all the successive blades, considered two by two, of the j-th row,
for the set of stator blades of the j-th row, said azimuthal angular spacing may not be uniform, i.e. there are at least two different azimuthal angular spacings Δθ_{j,1} and Δθ_{j,2}. In other words, for the set of stator blades of the j-th row, there are at least two different azimuthal angular spacings Δθ_{j,1} and Δθ_{j,2}.

It is also possible that:
said respective reference axes of the stator blades are arranged in several stator rows, each perpendicular to the longitudinal axis (X), each comprising several stator blades, and
there exists a sequence (Δ_{φi})_{1≤i≤B}_{_{T}} where B_{T} denotes the total number of stator blades and Δ_{φi} denotes the i-th azimuthal angular spacing when all the stator blades of all the stator rows, and their said respective reference axes, are projected onto a single plane perpendicular to the longitudinal axis (X), and:
said azimuthal spacings between successive stator blades, considered two by two, located in several rows of stator blades, are identical, i.e. there is only one constant azimuthal spacing: Δ_{φ1}, or

$$min \{ Δ {φ}_{i} \} \geq 360 ° / ( 4 * {\sum }_{j = 1}^{N} {B}_{j} ) with 1 \leq i \leq {\sum }_{j = 1}^{N} {B}_{j} ,$$

or preferably

$$min \{ Δ {φ}_{i} \} \geq 360 ° / ( 2 * {\sum }_{j = 1}^{N} {B}_{j} )$$

with Bⱼ denoting the number of stator blades in the j-th row, 1≤j≤N, N being a natural number. This last configuration better avoids the interaction of the wakes of the upstream stator blades with the downstream stator blades.

Preferably, Bⱼ≥2 with 1≤j≤N, more preferably 2≤Bⱼ≤10, with Bⱼ designating the number of stator blades placed in the j-th row of stator blades, counted from upstream to downstream starting from the row of rotor blades.

Bⱼ may be an even number.

The trailing edges of the stator blades of a row P₁ may be located downstream of the leading edges of the stator blades of the row P_{N}.

Also concerned is an aeronautical propulsion unit in which at least some of the rotor and stator blades are connected to a variable pitch system enabling their pitch angle to be changed by rotation about their respective axes.

It would also be possible to have an aeronautical propulsion unit wherein there are at least two families of stator blades, preferably at least three families of stator blades, and wherein each family of stator blades comprises several stator blades having the same geometric characteristics including the chord (C), the maximum thickness (e), the height, the camber, a sweep angle, a dihedral angle, etc., at least one of said geometric characteristics of one family being different from the same geometric characteristics of the stator blades of another family of stator blades.

The reference height chosen to define the pitch angle is 0.75 of the dimension of the longitudinal axis at the radially outer end of the blade in question.

The aircraft propulsion unit may comprise:
a hub provided with rotor blades,
an engine casing around which stator blades are arranged,
and, successively, along the longitudinal axis (X), from upstream to downstream, and radially inwardly relative to the engine casing:
at least one compressor,
at least one combustion chamber,
at least one turbine driving the compressor(s), and
an air inlet to the compressor(s), the air inlet being located downstream of the rotor blades and upstream of the stator blades.

This document also relates to a propulsion assembly for an aircraft,
the assembly comprising an aeronautical propulsion unit as described above and which comprises an engine casing around which the stator blades are arranged, and
the assembly further comprising an attachment structure for fixing the aeronautical propulsion unit to the aircraft, the attachment structure having, or defining, when viewed in a plane perpendicular to said longitudinal axis and at least partially intersecting one of the stator blades, a protuberance extending between two stator blades or axially adjacent to them,
the assembly being such that:
   around the longitudinal axis, an angular position at 12 o'clock is defined as positioned vertically upwards relative to the longitudinal axis (X), and an angular position at 6 o'clock as positioned vertically downwards relative to the longitudinal axis, and
   at least some of the stator blades are distributed axially according to a linear law such that, among these blades, the blade at 12 o'clock is the one furthest upstream of said blades and the one at 6 o'clock is the furthest downstream.

This document relates to a propulsion assembly as described above:
wherein said respective reference axes of the stator blades are arranged in several stator rows, each perpendicular to the longitudinal axis, each comprising several stator blades, one of the rows being located axially further downstream than the other row, and
which comprises a casing around which the stator blades are arranged, the assembly further comprising an attachment structure for fixing the aeronautical propulsion unit to the aircraft, the attachment structure having, or defining, when viewed in a plane perpendicular to said longitudinal axis and at least partially intersecting blades of at least one of the two stator rows, a protuberance relative to the casing and extending
between two blades of the intersected stator row, said respective reference axes of the blades of the intersected stator row, or of the blades of one of the two stator rows (16), being further away both:
axially, from said respective reference axes of the rotor blades, and
circumferentially around the longitudinal axis (X), from the protuberance of the other stator row.

Each row of rotor or stator blades may comprise between 3 and 25 blades, preferably between 8 and 16.

The number of rotor blades is different from the number of stator blades. This condition is necessary in order to minimize the noise of the turbine engine. It should be noted that, in the case where the number of rotor and stator blades are equal, all the wakes of the rotor blades interact with the stator blades simultaneously, which increases the noise levels. It is therefore recommended that the number of rotor blades be greater than the number of stator blades.

The strength, C/E, defined as the ratio between the chord, C, and the azimuthal spacing between two consecutive stator blades in the azimuthal direction, E, is less than 3 over the entire span, being less than 1 at the tip in a preferred embodiment, i.e. at the radially outer ends (25) of two rotor or stator blades which are adjacent around the longitudinal axis (X).

The ratio S/D, between the minimum spacing S measured in the longitudinal direction between the pitch change axis of a propeller blade and that of a stator blade, and the engine diameter D, varies between 0.15 and 0.5, preferably between 0.2 and 0.35. It should be noted that the trailing edge of the blades of the upstream row of rotor blades is located at an axial position that is further upstream than the leading edge of the vanes of the downstream row of stator blades, in order to avoid interference between the two wheels.

In another embodiment of the invention, at least one row of upstream stator blades has trailing edges arranged upstream of the leading edges of a row of downstream stator blades.

The turbine engine may also comprise at least two rows of stator blades, one upstream and the other downstream, the blades of said rows being arranged relative to each other such that each blade of one row is arranged around the longitudinal axis to be between two stator blades of another row.

This makes it possible to locally increase the distance between the rotor blades and the stator blades of the second downstream row.

The rows of stator blades may comprise the same number of blades or a different number.

This document also relates to an aircraft having a longitudinal axis (X1) and comprising an aeronautical propulsion unit as described above, a fuselage and a wing to which the aeronautical propulsion unit is fixed, wherein the absolute value of the angle (∥β∥) between the longitudinal axis of the aeronautical propulsion unit and the longitudinal axis of the aircraft (X1) varies between 0.5° and 30°, preferably between 2° and 20°, or more preferably between 3° and 10°. The axis X1 may correspond to the roll axis of the aircraft. These values of the angle ∥β∥ make it possible to minimize the effects from installation and therefore the interaction of the upstream rotor blade tip vortices with the downstream stator blades, which can be a factor in the axial spacing of the stator blades.

### BRIEF DESCRIPTION OF DRAWINGS

Other features, details and advantages will become apparent upon reading the detailed description below, and upon analyzing the attached drawings, in which all the blades are unducted, and:

FIG. 1 is a partial schematic cross-section view of a turbine engine which is usable here, therefore with an upstream rotor and downstream stator, in a “pusher” configuration,

FIG. 2 is a schematic view of a propulsion unit in what can be a “puller” configuration, in what can be a takeoff phase, therefore with a greater angle of attack (angle α);

FIG. 3 is a partial schematic cross-section view of a turbine engine which is usable here, in a “puller” configuration,

FIG. 4 is a schematic view of a turbine engine which is usable in a “puller” configuration and differing from FIG. 3 essentially in the position of the pylon downstream of a row of stator blades,

FIG. 5 and FIG. 6 are schematic views illustrating a possible configuration of a turbine engine having two downstream rows of stator blades longitudinally offset from each other and in which the blades of the upstream row are azimuthally offset relative to the blades of the downstream row,

FIG. 7 shows an upstream row of rotor blades and a downstream row of stator blades, the blades of the stator row not extending as far radially outward as the blades of the rotor row,

FIG. 8 shows a stator blade (upper) and a cross-section of the blade along line AA′ (lower),

FIG. 8A illustrates the sweep angle,

FIG. 8B illustrates the dihedral angle,

FIG. 9 to FIG. 13 are representational views of different embodiments of the invention in which one can see that the stator blades are longitudinally offset relative to each other, the stator blades being shown in a linear view,

FIG. 14 is a schematic view of an arrangement of one row of rotor blades and two rows of stator blades (left), and a schematic representation of the stator blades in a front view (right),

FIG. 15 is a schematic representation of a turbine engine in a “puller” configuration, comprising stator blades arranged in a V-shape,

FIG. 16 is a schematic view of a turbine engine in a “puller” configuration, comprising stator blades in a two-row configuration.

### DESCRIPTION OF EMBODIMENTS

As has been noted, a technical problem addressed in the present description concerns the aerodynamic and acoustic optimization of an unducted aeronautical propulsion unit, in particular of the “Unducted Single Fan” (USF) type, and in particular the reduction of:
noise from interactions between the rotor blades and the stator blades,
the inherent noise of the blades, in particular the stators.

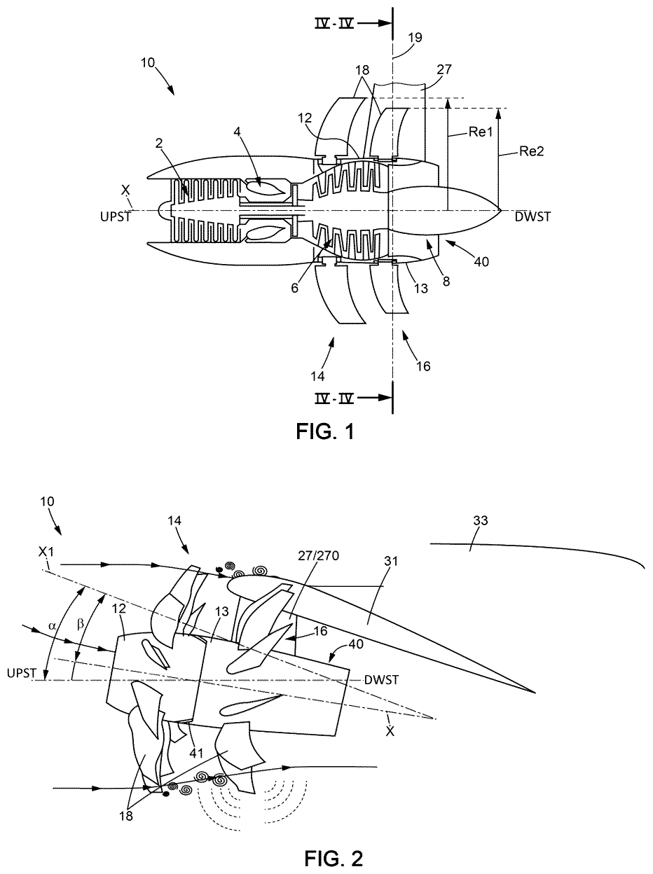

By way of example, an (aeronautical) propulsion unit compatible with what the invention proposes could be a turbine engine, such as the one in FIGS. 1 to 3, which is of the USF type.

Any (aeronautical) propulsion unit referred to here, such as the turbine engine 10, comprises a hub 12 located upstream (UPST) of an engine casing 13.

A plurality of unducted rotor blades 14 are mounted on (around) the hub 12, and, axially downstream (DWST) of all of them, a plurality of unducted stator blades 16 are mounted on (around) the engine casing 13. The two series of blades 14, 16 are arranged around the longitudinal axis X of the propulsion unit.

The hub 12 and the engine casing 13 may be combined under the term nacelle 40, the nacelle 40 being the structure around which the rotor 14 and stator 16 blades are arranged and extend. The nacelle 40 itself is fixed to the aircraft to be driven by the aeronautical propulsion unit referred to herein.

As will have already been understood, orientation qualifiers such as “longitudinal”, “radial”, or “circumferential”, are defined in relation to the longitudinal axis X of the propulsion unit in question, as with the turbine engine 10.

The longitudinal direction here corresponds to the direction of advancement of the propulsion unit or to the axis of rotation of the blades of the upstream rotor 14.

In particular, the longitudinal direction may be coincident with a horizontal direction, i.e. perpendicular to the gravitational field. The relative qualifiers “upstream” (UPST) and “downstream” (DWST) are defined in relation to each other with reference to the flow of gases in the propulsion unit, along the longitudinal direction (excluding a reverse operation of the rotor blades 16).

The angular position of each of the blades 14, 16 around the longitudinal axis X is identified in relation to a clock face (here viewed from upstream for example) on which the angular positions at 12 o'clock, 3 o'clock, 6 o'clock, and 9 o'clock are positioned in a conventional manner. The angular position at 12 o'clock is therefore positioned vertically upwards relative to the longitudinal axis X and the angular position at 6 o'clock is positioned vertically downwards relative to the longitudinal axis X. The angular position at 3 o'clock is positioned horizontally to the right relative to the longitudinal axis X and the angular position at 6 o'clock is positioned horizontally to the left relative to the longitudinal axis X. An axis extending radially through the angular positions at 12 o'clock and 6 o'clock is thus perpendicular to an axis extending radially through the angular positions at 3 o'clock and 9 o'clock.

Absolute position qualifiers such as the terms “top”, “bottom”, “left”, “right”, etc., or relative position qualifiers such as the terms “above”, “below”, “upper”, “lower”, etc., and orientation qualifiers such as the terms “vertical” and “horizontal”, refer here to the orientation of the figures and are considered in an operational state of the propulsion unit, typically when it is installed on an aircraft on the ground.

In this state of the turbine engine 10, the axis passing through the angular positions at 12 o'clock and 6 o'clock may extend in the direction of the gravity field, i.e. vertically. However, one can deduce that a rolling movement during flight of the aircraft on which the propulsion unit is mounted will cause a rotation of the vertical and horizontal directions, as considered in the figures, around the longitudinal axis X. In the same manner, a rolling movement during flight of the aircraft on which the propulsion unit is mounted will cause a rotation of the axis passing through the angular positions at 12 o'clock and 6 o'clock and of the axis passing through the angular positions at 3 o'clock and 9 o'clock around the longitudinal axis X.

A “lateral zone” of the turbine engine 10 refers to a zone that is circumferentially near the 3 o'clock angular position or the 9 o'clock angular position. Similarly, an “upper zone” and a “lower zone” of the propulsion unit respectively refer to a zone that is circumferentially near the 12 o'clock angular position and to a zone that is circumferentially near the 6 o'clock angular position.

The stator blades 16 are thus each fixed around the longitudinal axis X. This does not exclude the possibility that each stator blade 16 may have a variable pitch.

If the aeronautical propulsion system considered is (or comprises) a turbine engine, it will therefore be a turbine engine successively comprising, parallel to the longitudinal axis (X), from upstream to downstream inside the nacelle 40 (including under the engine casing 13):
one (or more) compressor(s) 2,
at least one combustion chamber 4,
one (or more) turbine(s) 6 driving the compressor(s), and
at least one exhaust nozzle 8.

The stator blades 16 may each be centered on an axis that may or may not be coincident with the longitudinal axis X. In the examples presented, they are centered on the longitudinal axis X.

The turbine engine 10 may comprise a gearbox to decouple the rotational speed of the turbines 6 from the rotational speed of the rotor blades 14.

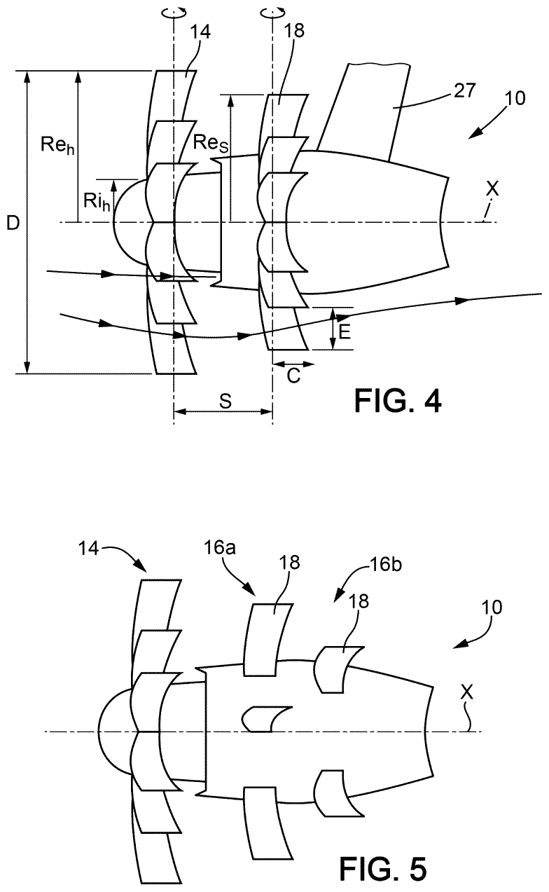

As is schematically shown in FIGS. 2, 3 and 4, the propulsion unit may have a so-called “puller” configuration (rotor blades 14 and stator blades 16 located at an upstream end portion of the propulsion unit) or, as is schematically shown in FIG. 1, a so-called “pusher” configuration (rotor blades 14 and stator blades 16 located at a downstream end portion of the propulsion unit).

In the puller configuration, the upstream rotor blades 14 and the downstream stator blades 16 may surround a section of the compressor(s) 2 of the turbine engine or of the gearbox. In the pusher configuration, the upstream rotor blades 14 and the downstream stator blades 16 may surround a section of the turbine(s) 6 of the turbine engine 10.

Regardless of the type of propulsion unit (turbine engine, hybrid, etc.), a fastening system 27 comprising a pylon will enable the propulsion unit to be fastened to an aircraft which is thereby equipped with it, and more precisely to its airfoil (wing) 31, or to its fuselage 33, or to any other suitable part. The fastening system is formed at a protuberance 36 formed face to face with the casing and extending between two blades. The fastening system is formed in a plane P1 perpendicular to said longitudinal axis (X) and at least partially intersecting blades 18 of at least one of the stator rows.

The upstream rotor blades 14 and/or the downstream stator blades 16 may have variable pitch. It is thus possible to adapt the pitch of the blades of the turbine engine 10 according to the operating point of the propulsion unit or the flight phase. A pitch change system 38 may be provided, located partly in the nacelle 40 (hub 12 and/or casing 13) in order to adapt the angle of attack of the blades for each flight phase. Each blade 14, 16 may thus be adjusted in rotation about a respective pitch change axis 19.

The individual pitch change axis 19 (possibly for each) of the blades is an axis:
extending radially and/or positioned longitudinally at a median portion of the respective blade, and
around which the pitch angle of a blade may be adapted.

In this regard, the present disclosure covers the cases where:
the pitch change axis is perpendicular to the longitudinal axis X,
the pitch change axis is not perpendicular to the longitudinal axis X, i.e. it is inclined;
for example, if the pitch change axis has a longitudinal component and/or a circumferential component, with reference to the longitudinal axis X.

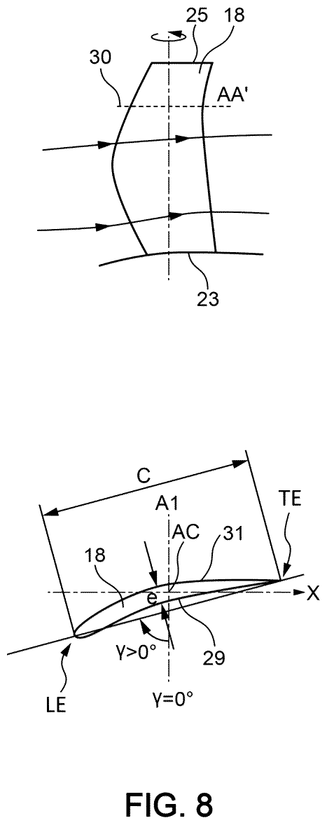

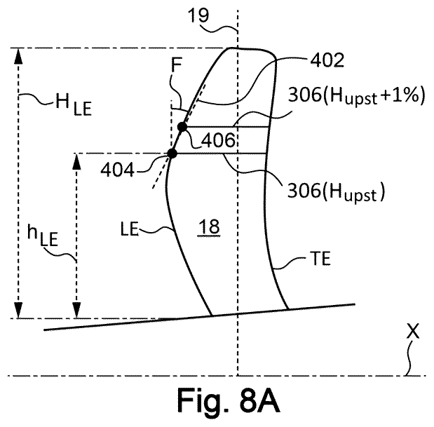

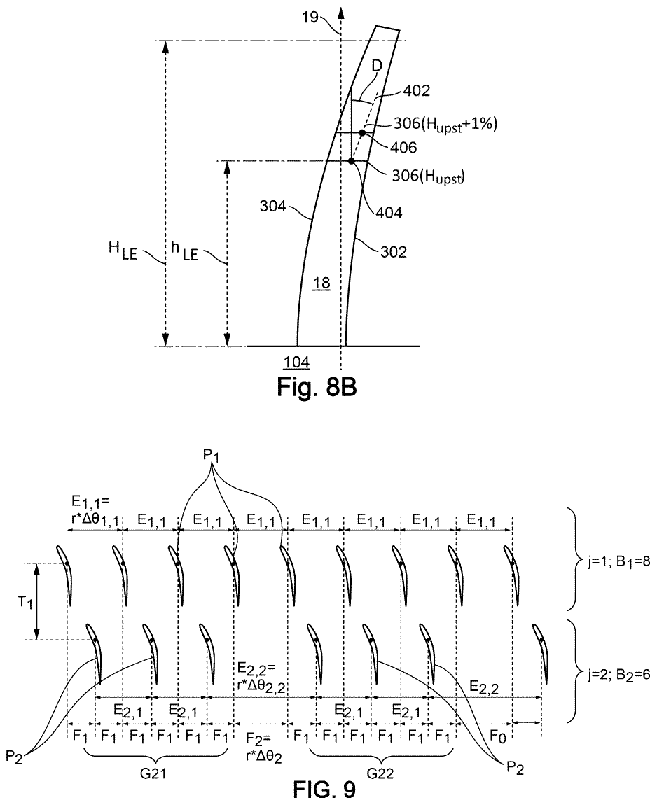

In order to (re)define, if necessary, the pitch angle of a blade more precisely, it is specified that each stator blade 16 defines an aerodynamic profile as shown in particular in FIG. 8. For this purpose, each downstream stator blade 18 comprises a stack of sections 30 in the radial direction. One of the sections 30 is shown in FIG. 8. Each section 30 extends in a respective section plane which is perpendicular to the radial direction of extension of the corresponding downstream stator blade. Each section 30 comprises a leading edge LE upstream and a trailing edge TE downstream, a pressure-side line 29 and a suction-side line 31 extending between them. Each section 30 defines an aerodynamic profile. Each section 30 also comprises a chord C defined by a straight portion connecting the leading edge LE to the trailing edge TE.

The pitch angle γ of each stator blade 16 (see FIG. 8) will correspond to the angle formed between, on the one hand, a first axis A1 which is defined by the intersection between the section plane of a reference section 30 among the stack of sections 30 of the downstream stator blade 18 and a plane perpendicular to the longitudinal axis X which may comprise the pitch axis 19 of the downstream stator blade 18 (when the pitch change axis is perpendicular to the axis X, which is normally the case but is not obligatory), and on the other hand, the chord line C of the reference section 30 of the stator blade 16. The pitch angle γ is measured on the upstream side of the plane perpendicular to the longitudinal axis X, which, as above, may comprise the pitch axis 19 of the stator blade. The pitch angle γ is measured positively in a direction from the first axis A1 to the chord line C of the reference section 30, and more particularly in a direction that is coincident with the direction from the pressure-side line 29 to the suction-side line 31.

The reference section 30 of each stator blade 18 here is located, on the corresponding downstream stator blade, at a radial distance from the longitudinal axis X which corresponds to approximately 75% of the radially outer radius of the corresponding downstream stator blade 18.

With reference to FIG. 8A, it is also possible to define a sweep angle F for the stator blade 18, varying according to the blade height Hᵤₚₛₜ. By definition, the sweep angle F is the angle between the pitch axis 19 and the projection, in the plane of the pitch axis 19 and main axis X (plane of the page for FIG. 8A), of the line 402 connecting the leading edge LE to the blade height Hᵤₚₛₜᵣ concerned, 404, and the leading edge LE to the blade height Hᵤₚₛₜᵣ concerned plus 1% of the total height H_{LE}, 406.

With reference to FIG. 8B, it is also possible to define a dihedral angle D of the stator blade 18, varying according to the blade height Hᵤₚₛₜ. By definition, the dihedral angle D is the angle between the pitch axis 19 and the projection, in the plane perpendicular to the main axis X containing the pitch axis 19 (plane of the page for FIG. 5), of the line 402. As explained above, the latter connects the leading edge LE to the blade height Hᵤₚₛₜᵣ concerned, 404, and the leading edge LE to the blade height Hᵤₚₛₜᵣ concerned plus 1% of the total height H_{LE}, 406.

Each rotor or stator blade extends in a transverse direction, which may be radial, from the hub 12 (for the rotor blades 14) or the casing 13 (for the stator blades 16) so as to define a radial dimension between said hub or casing and a radially outer end of the blade 14, 16 concerned. In other words, the radial dimension of a blade corresponds to its height between said radially inner 23 and radially outer 25 ends. The radially inner end of each blade 14, 16 is arbitrarily considered to be located at the hub 12 or the casing 13; it is there that it is fixed or connected to the hub 12 or the casing 13. The radially outer end of each blade here is a free end (i.e. unducted).

Furthermore, each rotor 14 and stator 16 blade has a radially inner radius, respectively Riₕ, Riₛ, considered as the radial distance to the longitudinal axis X from the radially inner end of the blade, for example located at the (i.e. closest to) the hub 12 or the casing 13 (for example, along the direction of the pitch axis 19). A radially outer radius, such as Reₕ or Reₛ (FIG. 7), of each blade is considered as the radial distance to the longitudinal axis X from the radially outer end of said blade, i.e. the maximum radius of the blade.

On this basis, the span of a blade is consequently the radial distance between its inner 23 and outer 25 ends, with L1=Reₕ−Riₕ for a rotor blade 14, and L2=Reₛ-Riₛ for a stator blade 16.

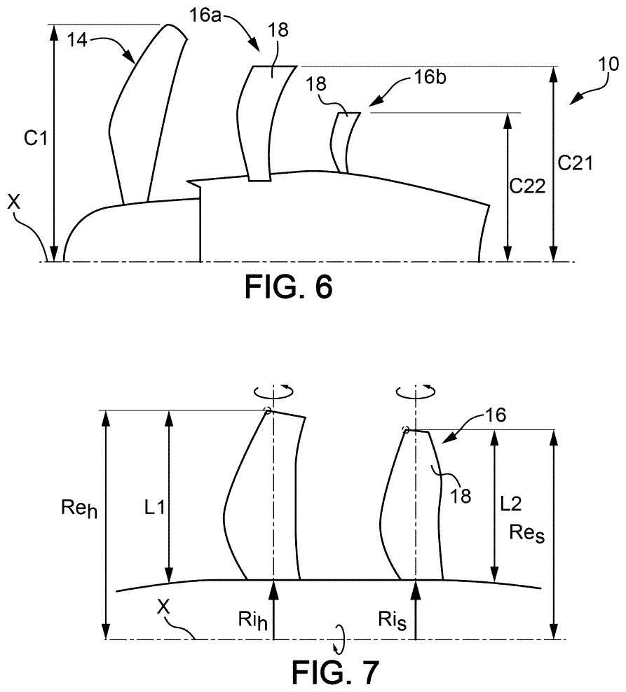

As can be seen in FIGS. 5 and 6, the turbine engine 10 may comprise a row of rotor blades 14 and at least one row of stator blades 16. In the present case, the turbine engine comprises two rows of stator blades, one upstream 16a and one downstream 16b. Thus, along the longitudinal axis (X), at least two stator blades are at different axial positions from each other. The blades 18 of the upstream row of stator blades 16a may be arranged in a staggered arrangement relative to the stator blades 18 of the downstream row 16b (FIG. 5).

According to the present document, the stator blades 18 may be such that, for each pair of two stator blades, the ratio between the maximum chord of said two blades is between 0.8 and 1.25, preferably between 0.9 and 1.11, the maximum chord being measured on a radial cross-section of the stator blade 16. This makes it possible to adapt the chord for each blade according to their axial and/or azimuthal position while limiting the differences in mass between blades, which can help with the mechanical and/or dynamic balancing of the aeronautical propulsion unit.

In one possible configuration, illustrated in FIG. 5 and FIG. 6, all the rotor blades 14 may have a span greater than the span of all the stator blades 18. In other words, between the respective free radially outer 25 and radially inner 23 ends, the shortest rotor blade has a span (min{L1}) that is greater than the longest stator blade (max{L2}).

In the various embodiments shown in the figures, all the pressure-side faces of the stator blades are oriented in a same circumferential direction around the longitudinal axis. Thus, all the stator blades have a pressure-side face and a suction-side face. They therefore do not have a symmetrical profile.

The term “row” refers to an alignment of blades in the azimuthal or circumferential direction. When a plurality of stator blades are arranged in a same row, they have the same reference axis. For example, the blades could have circumferentially aligned leading edges, i.e. at the same axial position when the stator blades of a same row are identical and have the same pitch angle γ. The same may be true for the trailing edges, which indicates that all the blades of a same row have the same axial dimension and the same pitch angle γ. The number of stator blade rows will be defined by a number N, which is a natural number.

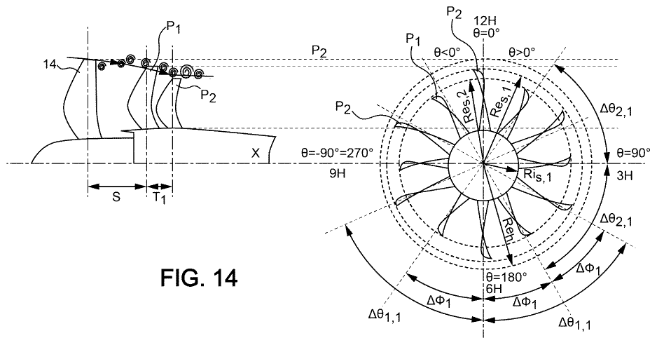

The blades may also have different geometric characteristics depending on their longitudinal (or axial) position and/or their azimuthal position. The geometric properties targeted include, for example, truncation, clipping, chord, pitch, camber, sweep angle, dihedral angle, etc. Indeed, the stream tube generated by the rotor blades contracts during high-thrust and low-speed operating points, such as during takeoff. The contraction of the stream tube is illustrated in FIG. 14. Thus, it would seem necessary to increase the clipping (or truncation) of the stator blades 16 located downstream.

As can be seen in FIG. 5, the blades 18 of the row of stator vanes may all be aligned in the azimuthal direction, meaning that their respective axes or reference axes or pitch axes 19 are all located in a same plane. They may also all have the same span (L2) and be inscribed within a primary circle C1.

The stator blades 18 of the upstream row 16a may be inscribed within a first secondary circle C21, and the stator blades 18 of the downstream row 16b may be inscribed within a second secondary circle C22. The radii of the secondary circles C21, C22 are less than the radius C1 of the primary circle, said radii all being centered on the longitudinal axis X of the turbine engine. In one particular embodiment, the radii C21, C22 of the secondary circles decrease downstream. In other words, the radius C21 is greater than the radius C22. This observation can still be true with a greater number of rows of stator vanes, and is applicable to the embodiments which will be described with reference to FIGS. 9 to 14.

With reference to this figure but also applicable to all embodiments illustrated in the figures and in particular those of FIGS. 9 to 14, the stator blades 18 located furthest downstream 16b may have a mean chord, along the span, that differs from those 18 located further upstream 16a. Preferably the mean and/or maximum chord of the downstream stator blades 16b may be less than the mean and/or maximum chord of the upstream stator blades. In addition, at least some of the stator blades 16a, 16b may have said respective reference axes for pitch angle adaptation, at least some of the pitches of the stator blades located further upstream being able to be different from at least some of the pitches of the stator blades located further downstream. Some of the stator blades in a same row could have different pitch angles, this being of particular interest for the stator blades on either side of the pylon.

The radial dimensions of the stator blades 16 in each row of stator blades may have geometric clipping (or truncation), which has already been presented above with reference to the circles C1, C21 and C22.

The geometric clipping may be defined such that the

$$geometric clipping = \frac{R {e}_{h} - R {e}_{s}}{R {e}_{h} - R {i}_{h}} ,$$

with:
Reₕ and Reₛ being the radii at the respective free radially outer ends (25) of the rotor and stator blades, respectively, and,
Riₕ and Riₛ being the radii at the respective free radially inner ends (23) of the rotor and stator blades,
and, if the rotor blades have different free radially outer end radii between them, Reₕ is then defined by the smallest of the radii at the respective free radially outer ends (25) of all the rotor blades, and the values of said geometric clipping are between −10% and +30%, depending on the position around the axial and longitudinal axis (X) axis of the stator blade concerned, preferably between 5% and 20%.

We now refer to FIGS. 9 to 13, which illustrate several embodiments of the invention in which at least two stator blades 16 are axially offset from one another. One can see that the arrangement of the stator blades represents several rows, each having a certain number of blades which may be the same or different.

The following mathematical notation will be used to describe the rows of stator vanes:

We use the following notation for the sequence (Bⱼ)_{1≤j≤N}, where Bⱼ denotes the number of vanes placed in the j-th row.

$${B}_{stator} = {\sum }_{j = 1}^{N} {B}_{j}$$

where Bₛₜₐₜₒᵣ corresponds to the total number of stator blades in all rows of stator blades. Pⱼ will also denote the blades 18 of the j-th row. The notation for the azimuthal angular spacing is Δθ_{j,k} when it designates the spacing between two consecutive stator blades of a same j-th row and is Δ_{φi} when it concerns two consecutive stator blades, these blades 18 belonging to a same row or to two different rows, where 1≤i≤Bₛₜₐₜₒᵣ. We also use the following notation for the sequence (Tⱼ)_{1≤j≤N-1}, where Tⱼ designates the axial distance between the rows of stator blades j and j+1. In FIGS. 9 to 13, the points located on the stator blades indicate the reference axes of the blades 18 which may be angular pitch change axes as described with reference to FIG. 8, these points being used to identify the distance Tⱼ.

In FIGS. 9 to 14, the stator blade rows have been unrolled into a linear view such that the angular spacings (Δθ_{j,k} and A_{φi}) have been replaced by the length of the spacings (E_{j,k} and Fᵢ). Thus, E in FIGS. 9 to 13 corresponds to E_{j,k}=rΔθ_{j,k}, and Fᵢ=rΔ_{φi} where the angles are given in radians and r corresponds to a radial position on the blade measured relative to the longitudinal axis X.

Depending on the axial position of the vanes, different stator blade geometries or “families” will be preferred, which will be characterized by one or more of the following variabilities relative to a reference geometry:
A variation in the level of clipping as defined above: the blades located furthest downstream will have a level of clipping or truncation that is greater than or equal to those located upstream. Indeed, the tip vortex from the rotor blades moves closer to the hub as it progresses downstream due to the contraction of the streamlines downstream of said rotor blades 14. Thus, an increase in the distance between the upstream rotor blades 14 and the downstream stator blades 16 implies having to increase the “clipping” of the stator vanes furthest downstream in order to avoid interaction with the blade tip vortex from the rotor blades 14.
A variation in the profile chord: it may be advantageous for the stator blades located furthest downstream, those located in the downstream rows, to have a mean (along the span) and/or maximum chord that is different from the mean and/or maximum chord of those located upstream. Preferably, the mean and/or maximum chord of the upstream stator blades will be greater than the chord of the downstream stator blades. It may decrease in the downstream direction. From an aerodynamic point of view, a significant portion of the flow gyration downstream of the rotor blades 14 is taken up by the row of stator blades 16 closest to the row of rotor blades 14 in the axial direction, which can reduce the chord required for the blades 18 of the rows of stator blades further downstream. In addition, this reduces the size of the stator wheel and facilitates its installation. For example, this would prevent the most downstream stator vanes from being contaminated by potential updrafts from the pylon or a wing.
A modification of the blade pitch, in order to better adapt to the incident flow and better account for the effects from installing the rows of stator blades on the turbine engine due to the presence of pylons and/or equipment, the shape of the aircraft fuselage, etc. In particular, for a given operating point, the pitches of the upstream stator blades may be different from the pitches of the downstream stator blades.
The sweep and/or dihedral angles of the stator blades 16 may be different for each row. In particular, a reduction in the sweep and/or dihedral angle is preferred for the stator blades 16 in the rows furthest downstream. The sweep and/or dihedral angle of the stator blades 16 increases the decorrelation of noise sources emitted by the stator. The greater the distance between the trailing edge of the rotor blades 14 and the leading edge of the stator blades 16, the more the wake of the rotor blades 14 dissipates and it is therefore possible to reduce the sweep and/or dihedral angle without degrading the acoustic performance. Reducing the sweep angle can simplify the mechanical strength of the blades 18.

In the embodiment of FIG. 9, the stator blades are distributed in two rows, a first row P₁ being an upstream row and a second row P₂ being a downstream row. In this example, the upstream row P₁ may comprise 8 blades and the downstream row P₂ may comprise 6 blades. These are non-limiting values. The blades of one of the upstream P₁ and downstream P₂ rows may be regularly distributed longitudinally around the axis so as to have a constant spacing E. In the example, it is the spacing E_{1,1} between the blades of row P₁ which is constant. The blades of the other row may be distributed into several groups, for example into at least two groups, which may be spaced apart from each other by a spacing value E_{2,2} that differs from the spacings between the blades of a same group. It would also be possible to have several rows of blades, each comprising several groups of blades, and each group could comprise the same number of blades or a different number of blades. The groups of blades may be regularly distributed around the longitudinal axis. The spacing between the blades 18 of a same group may be different from one group to another.

In the current case, in FIG. 9, the blades P₂ are distributed into a first group G₂₁ of three stator blades P₂ and a second group G₂₂ of three stator blades P₂. The groups of blades could also comprise a different number of blades.

One can see that the blades of the first group G₂₁ and also of the second group G₂₂ are spaced apart by a spacing value E_{2,1}, and the groups G₂₁ and G₂₂ are spaced apart by a spacing value E_{2,2}.

We now refer to FIG. 10 which represents another embodiment where several rows of stator blades are illustrated and, more particularly, two rows P₁ and P₂ here. The vanes P₁ may be regularly distributed around the longitudinal axis X, meaning at a constant spacing E_{1,1}. The same may be true for the blades P₂, having a spacing E_{2,1} which is also constant. The number of blades may be identical between all the rows. In one embodiment, the blades of a row may be arranged azimuthally staggered relative to the blades of the longitudinally adjacent rows. FIG. 10 shows such an arrangement for the particular case with two rows.

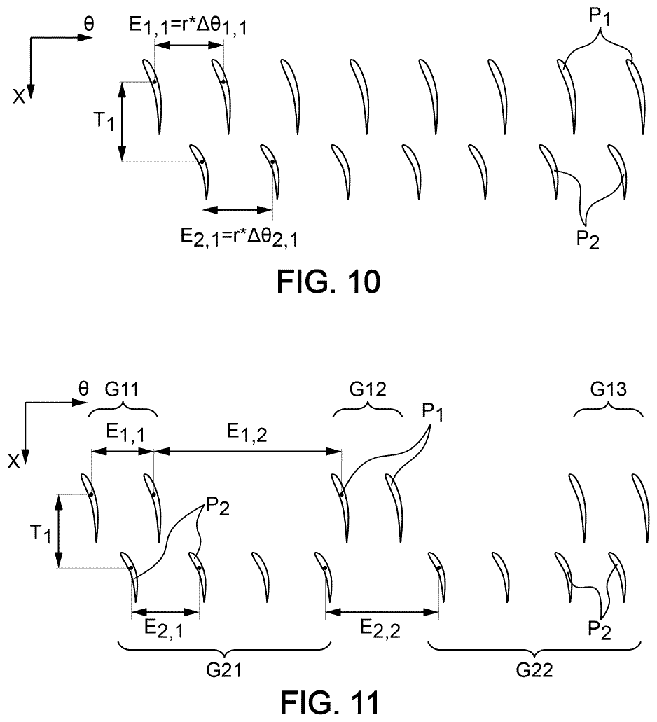

FIG. 11 illustrates a particular case comprising several rows of stator blades, each row of stator blades comprising several groups of stator blades, here three groups G11, G12, G13 for the first row of blades P₁, each comprising two blades, and two groups G21, G22 for the second row of blades P₂, each comprising four blades P₂.

With reference to FIGS. 10 and 11, locally increasing the distance between the rotor blades 14 and the stator blades 16 for the vanes of the second row makes it possible to:
Decorrelate the acoustic sources located at the leading edge of the stator blades. The axial distance T₁ (axial spacing between the rows) between the leading edge of a vane of group G11 and a vane of group G21 which is arranged circumferentially between two vanes of group G11, i.e. located in the same circular sector as the vanes of group G11, controls, to the first order, the delay of the emitting sources at said vane of group G21 compared to the emitting sources at the vanes of group G11. This parameter can therefore be chosen so as to maximize the possible destructive interference between these sources and thus reduce noise.
   It should be noted that this difference in distance between the leading edges of two adjacent vanes in the azimuthal direction may be achieved by modifying the pitch angle between these two adjacent blades, by modifying the chord (or other geometric parameters of the blades), and/or by increasing the axial distance between the reference axes, for example the pitch change axes, of these two adjacent blades.
Limiting multi-reflections between adjacent vanes. This type of propulsion unit architecture operates at lower rotation speeds than conventional turbojets. Consequently, the line frequencies will be lower and the associated wavelengths longer, which increases the risk of multi-reflections. The pattern presented here thus makes it possible to limit these at two levels:
   Placing the vanes in multiple rows and in a staggered pattern can reduce the overlap between two adjacent vanes and thus limit multi-reflections. This offers the advantage of mitigating this phenomenon without having to reduce the azimuthal spacing between the vanes, i.e. without having to reduce the number of stator blades.
   Distributing the stator vanes into two rows instead of one allows increasing the spacing between two adjacent vanes in the first row. It is then possible to increase E sufficiently for it to be greater than or less than the wavelength of the first blade pass frequency in order to limit or benefit from reflection effects at this frequency. Note that “multi-reflections” may be beneficial for reducing noise. “Grid effects” may help reduce noise.

As can be seen in the embodiments of FIGS. 9 to 11, the Tⱼ values are such that the trailing edges of the blades of an upstream row can be located upstream of the leading edges of a row immediately downstream. This is applicable to any number of rows of stator blades, preferably between 2 and 4 rows.

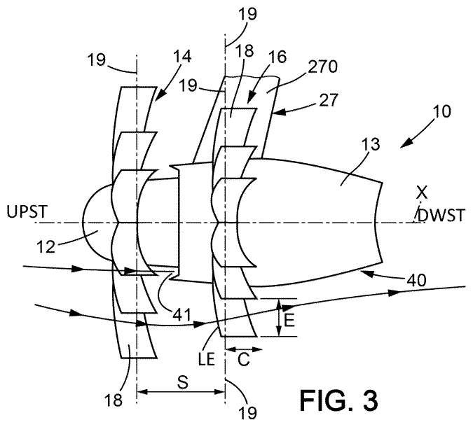

In most embodiments, S≥max{Tⱼ}will be chosen, with 1≤j≤N−1, N being the number of rows of stator blades and S being the distance between the reference axes of the rotor blades and the reference axes of the stator blades of the row immediately downstream (S is shown in FIG. 3). This makes it possible to limit the axial spacings of the rows of stator blades in relation to their spacing relative to the propeller, thereby limiting the axial length and weight of the aeronautical propulsion unit.

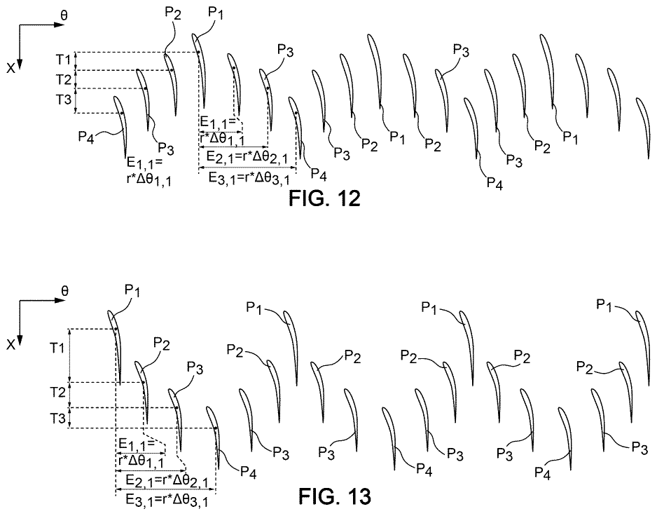

It would also be possible to have several rows of stator blades, i.e. at least two stator rows, which may have an azimuthal overlap of the blades. Thus, the Tⱼ values are such that the trailing edges of the blades of an upstream row may be located downstream of the leading edges of a row immediately downstream, and upstream of the trailing edges of said downstream row (FIGS. 12 and 13). In one particular embodiment illustrated in FIG. 12, the trailing edges of the stator blades of the most upstream row of stator vanes are all circumferentially/azimuthally aligned and positioned axially downstream of the leading edges of the stator vanes of the most downstream row of stator vanes.

Such an arrangement can be seen in the illustrations of FIGS. 12 and 13. These figures show four rows of blades P₁, P₂, P₃ and P₄. There could also be N rows. The blades 18 are arranged to form a (more or less) sinusoidal pattern azimuthally. In one embodiment (FIG. 12) the pattern is such that the sine curve has an upstream-oriented curvature and in another embodiment (FIG. 13) the pattern is such that the sine curve has a downstream-oriented curvature. More precisely, in the embodiment of FIG. 12, the leading edges of the stator blades of the rows P₁ are positioned axially and circumferentially so as to form a succession of concave patterns. The orientation chosen for considering whether the surface is concave or convex is the orientation from downstream to upstream. Indeed, in FIG. 12, one can see that a rounded concave pattern is formed between two leading edges of adjacent vanes of the most downstream row of stator vanes P₄, and this curve is thus above the straight line joining said leading edges. In FIG. 13, the leading edges of the stator blades of the rows P₁ are positioned axially and circumferentially so as to form a succession of convex patterns. Indeed, in FIG. 13, one can see that a rounded convex pattern is formed between two leading edges of adjacent vanes of the most upstream row of stator vanes P₁, and this curve is thus below the straight line joining said leading edges. Each pattern may have a semicircular concave or convex shape.

In the embodiments of FIGS. 12 and 13, one can see that the first row P₁ may comprise B₁ blades P₁, the second row P₂ may comprise B₂=2B₁ blades, the third row P₃ may comprise B₃=2B₁ blades P₃, . . . , the last row P_{N} may comprise B_{N}=B₁ blades P_{N}.

In one embodiment, the spacing Tⱼ may increase from the first upstream row to the last downstream row (FIG. 12). The spacing Tⱼ could also be constant. In another embodiment, the spacing Tⱼ may decrease from the first upstream row to the last downstream row (FIG. 13).

The distributions of stator blades presented in FIGS. 12 and 13 have the same advantages as those mentioned above with reference to FIGS. 9 to 11, but have additional specific features:
The successive spacings Tⱼ, more specifically T₁, T₂, T₃, allow defining a different phase shift between, respectively, rows 1 and 2, 2 and 3, 3 and 4, unlike in FIGS. 9 to 11, which only allowed for a single phase shift value. This therefore makes it possible to find the optimal spacing combination that minimizes interaction noise by creating destructive interference. The triplet (T₁, T₂, T₃) may be optimized according to the blade pass frequency and/or the operating point for which noise reduction is sought.
The vanes in this pattern are closer together and overlap more than in the previous pattern, which makes it potentially more compact than the previous one (because the distances between two successive leading edges are reduced). This offers an advantage in terms of occupied volume and frees up space for the installation of a pylon, for example. However, the azimuthal spacings of certain rows may be chosen to be greater (or less) than the wavelength of the first blade pass frequency at a certain operating point or points in order to reduce (or maximize) multi-reflections.

FIG. 14 illustrates an embodiment comprising several rows of stator blades and, here, a first row of blades P₁ having a radial span greater than the blades P₂ of a second row of blades. The blades P₁ and P₂ of the two rows are arranged in such a way that the blades are staggered in the azimuthal direction.

In this embodiment, said azimuthal spacings are identical between the reference axes of the successive stator blades, considered two by two, located in several rows of stator blades, meaning that there is only one, constant, azimuthal spacing: Δ_{φ1}. Preferably, in order to avoid the interaction of the wakes from the upstream stator blades with those from the downstream ones, it is recommended that

$$min \{ Δ {φ}_{i} \} \geq 360 ° / ( 4 * {\sum }_{j = 1}^{N} {B}_{j} )$$

with 1≤j≤N and 1≤i≤B_{T}, or preferably

$$min \{ Δ {φ}_{i} \} \geq 360 ° / ( 2 * {\sum }_{j = 1}^{N} {B}_{j} )$$

with Bⱼ designating the number of stator blades in the j-th row, 1≤j≤N, N being a natural number representing the number of rows and B_{T} designating the total number of stator blades, i.e. where

$${B}_{T} = {\sum }_{j = 1}^{N} {B}_{j} .$$

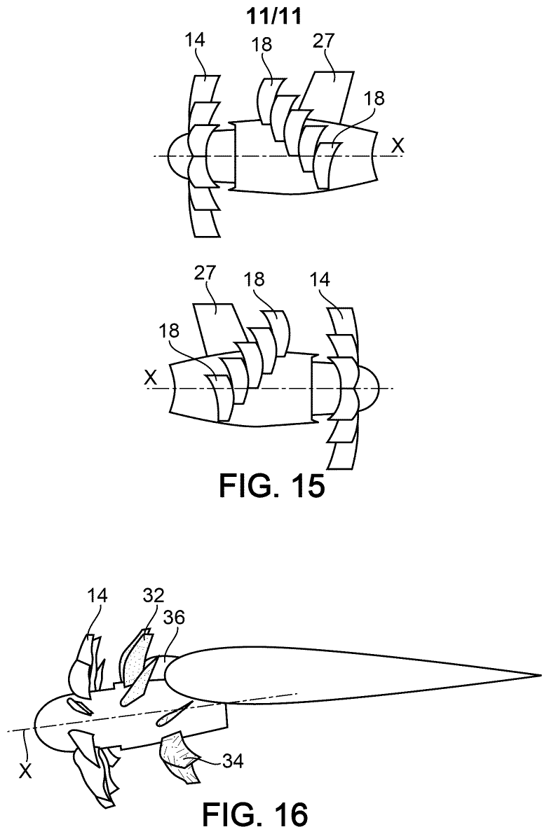

FIG. 15 illustrates a penultimate embodiment in which the stator blades 18 are arranged to form a V-shaped pattern, a first arm of the V extending on a first side of the turbine engine between 12 o'clock (i.e. near the pylon 27) and 6 o'clock and a second arm of the V extending on a second side of the turbine engine between 6 o'clock and 12 o'clock. The blades of each arm are distributed according to a linear law such that the vane at 12 o'clock is the most advanced, i.e. upstream, and the one at 6 o'clock is the furthest back, i.e. downstream. This configuration is advantageous because it allows integrating the stator blades 16 close to the pylon 27, which may be connected to the aircraft, and to axially distance the stator blades 16 not having integration constraints related to the positioning of the pylon 27. By axially distancing the stator blades 16, it is possible to reduce the interaction of the wake from the rotor blades 14 with the stator blades 16 and therefore the noise emitted by the aeronautical propulsion unit 10.

In a final embodiment, illustrated in FIG. 16, one can see that the stator blades are arranged so as to form two successive rows 32, 34. Here, the term row refers to a succession of stator blades that do not necessarily form a 3600 ring. There are therefore two series of blades or rows of blades that together form a ring extending over 360°. In this last embodiment, illustrated in FIG. 16, one can see that the stator blades are arranged so as to cover two disjoint circular sectors. Thus, in this example, the blades of the first stator row 32 cover the “upper” circular sector (extending from 9 o'clock to 3 o'clock via 12 o'clock, as viewed from upstream), while the blades of the second row 34 cover the “lower” circular sector (extending from 3 o'clock to 9 o'clock via 6 o'clock, as viewed from upstream). More particularly, the vanes of the upper sector are circumferentially disjoint in relation to the lower sector. In other words, they do not overlap circumferentially. This configuration is advantageous because it allows integrating the stator blades 16 further upstream relative to the pylon 27 and/or wing and/or aircraft, and to axially distance the stator blades 16 that do not have constraints on their integration with the aircraft. By axially distancing the stator blades 16, it is possible to reduce the interaction of the wake from the rotor blades 14 with the stator blades 16 and therefore the noise emitted by the aeronautical propulsion unit 10. By reducing the number of stator rows, the design of the blades 18 and their integration into the aeronautical propulsion unit are simplified.

1-33. (canceled)

34. An aeronautical propulsion unit (10) having a longitudinal axis (X) and comprising:
a plurality of unducted rotor blades (14), mounted to rotate about the longitudinal axis (X) and about a hub (12) of the aeronautical propulsion unit (10), and
a plurality of stator blades (16), spaced apart from the plurality of unducted rotor blades along said longitudinal axis, fixedly mounted about the longitudinal axis (X) and about a casing (13) of the aeronautical propulsion unit (10), downstream of the rotor blades (14) in the direction of the flow of gases from upstream to downstream along the propulsion unit, the stator blades being unducted, at least two stator blades being identical, two successive stator blades (18) about the longitudinal axis (X) having an azimuthal angular spacing Δ_{φi} between them that is defined by an angle between respective reference axes (19), said angle being:
either for adapting a pitch angle of said two successive stator blades, when these axes are projected in a plane perpendicular to the longitudinal axis (X) and if said two successive blades have a variable pitch angle,
or transverse to the longitudinal axis (X) and passing through radially inner ends (23) or radially outer ends (25) of said two successive stator blades or through their centers of gravity, respectively, if said two successive blades have a fixed pitch angle,
or, for one of said respective axes, for adapting a pitch angle of one of said two successive stator blades, when the blade has a variable pitch angle, and for the other, transverse to the longitudinal axis (X) and/or passing through the radially inner end (23) or the radially outer end (25) or through the center of gravity of an adjacent blade, when the blade has a fixed pitch angle,
the rotor and stator blades each having a free radially outer end (25) that is radially further from the casing (13) than a radially inner end (23) and the propulsion unit being characterized in that:
along the longitudinal axis (X), at least two stator blades (16) are at different axial positions from one another, and
for each pair of two stator blades, a ratio between a maximum chord of said two blades is between 0.8 and 1.25, preferably between 0.9 and 1.11, the maximum chord being measured on a radial cross-section of a stator blade.

35. The aeronautical propulsion unit (10) according to claim 34, wherein, between their respective free radially outer (25) and radially inner (23) ends, a shortest rotor blade (14) has a greater span than a longest stator blade (18).

36. The aeronautical propulsion unit according to claim 34, wherein all a pressure-side faces (29) of the stator blades (18) are oriented in a same circumferential direction around the longitudinal axis (X).

37. The aeronautical propulsion unit according to claim 34, wherein the stator blades (18) located furthest downstream have a mean chord, along their span, and/or a maximum chord, which is different from those located further upstream.

38. The aeronautical propulsion unit according to claim 34, wherein a mean chord and/or maximum chord of the stator blades (18) decreases axially from upstream to downstream.

39. The aeronautical propulsion unit according to claim 34, wherein:
the stator blades (18) and the rotor blades (14) each have a minimum radius, measured between the radially inner end of the blade (18) and the longitudinal axis (X), and
the minimum radius of any rotor blade is less than the minimum radius of any stator blade.

40. The aeronautical propulsion unit according to claim 34, wherein a radially outer end of each rotor blade (14) is inscribed within a first circle (20) and the radially outer end of each stator blade (180) is inscribed within a second circle (22), a radius (Reₛ) of the second circle (22) being less than a radius (Reₕ) of the first circle (20), said radii being centered on the same axis.

41. The aeronautical propulsion unit according to claim 34, wherein at least one of the following features a) to c) is implemented:
a) there are, around the longitudinal axis (X), several reference axes of stator blades (16), located at a same axial distance from reference axes of several rotor blades, and the radially outer end of each rotor blade (14) is inscribed within a primary circle (C1) and the radially outer end (25) of certain stator blades (18) is inscribed within a first secondary circle (C21) and the radially outer end of certain stator blades is inscribed within a second secondary circle (C22), the radii of the secondary circles (C21, C22) being less than the radius of the primary circle (Cl), said radii being centered on the same axis, and the radii (C21, C22) of the secondary circles decreasing in the downstream direction,
b) the stator blades (18) located furthest downstream have a different mean chord along the span than those located further upstream, preferably the mean chord of the downstream stator blades being less than the mean chord of the upstream stator blades, or
c) with at least some of the stator blades having said respective reference axes for adapting a pitch angle (19), at least some of the pitch angles (γ) of the stator blades located further upstream are different from at least some of the pitch angles (γ) of the stator blades located further downstream.

42. The aeronautical propulsion unit according to claim 34, wherein dimensions of the blades are determined so as to have a geometric clipping defined as follows:
$$geometric clipping = \frac{R {e}_{h} - R {e}_{s}}{R {e}_{h} - R {i}_{h}} ,$$
with:
Reₕ and Reₛ being the radii at the respective free radially outer ends (25) of the rotor and stator blades, respectively, and,
Riₕ being the radius at the radially inner end (23) of the rotor blades,
and, if the rotor blades have different free radially outer end radii between them, Reₕ is then defined by the smallest of the radii of the respective free radially outer ends (25) of all the rotor blades, and
values of said geometric clipping are between −10% and +30%, depending on the position around the axial and longitudinal axis (X) of the stator blade in question, preferably between 5% and 20%.

43. The aeronautical propulsion unit according to claim 34, wherein an axial distance between one of the respective reference axes of the rotor blades (14) and one of said respective reference axes of the stator blades (16) varies angularly.

44. The aeronautical propulsion unit according to claim 34, wherein leading edges and/or trailing edges and/or the reference axes of the stator blades are positioned axially and circumferentially so as to form a succession of convex and/or concave patterns.

45. The aeronautical propulsion unit according to claim 34, wherein:
said respective reference axes of the stator blades are arranged in several stator rows, each perpendicular to the longitudinal axis (X), each comprising one or more stator blades,
parallel to the longitudinal axis (X), two axially successive stator rows (16, 16a, 16b) have between them an axial distance (Tⱼ), and
in the case where there are at least three stator rows, the axial distances (Tⱼ) vary according to the stator rows (16) in question.

46. The aeronautical propulsion unit according to claim 34, wherein:
said respective reference axes of the stator blades are arranged in several stator rows, each perpendicular to the longitudinal axis (X), each comprising one or more stator blades,
with S being the smallest axial distance between said respective reference axes of one of the rotor blades and one of the stator blades of the stator rows, there exists a sequence (Tⱼ)_{1≤j≤N-1}, where Tⱼ denotes the axial distance between two axially successive stator rows (16), j and j+1, such that S≥max{Tⱼ} with 1≤j≤N−1, N being a number of stator rows (16).

47. The aeronautical propulsion unit according to claim 34, wherein:
the reference axes of the rotor blades are all located in a same plane perpendicular to the longitudinal axis (X), in a single rotor row (14) of rotor blades,
said respective reference axes of the stator blades are arranged in several stator rows, each perpendicular to the longitudinal axis (X), each comprising one or more stator blades, and
$$1 \leq \frac{{max}_{j} \{ {T}_{j} \}}{{min}_{j} \{ {T}_{j} \}} \leq 10 ,$$
where Tⱼ denotes an axial distance between two axially successive stator rows (16), j and j+1, with 1≤j≤N−1, N being the number of stator rows (16) and j=1 corresponding to the row of stator blades closest to the rotor row (14).

48. The aeronautical propulsion unit according to claim 34, wherein there is a ratio C/E between a chord C and an azimuthal spacing E between two consecutive stator blades (16) around the longitudinal axis (X), such that C/E is less than 3 over an entire span of each stator blade.

49. The aeronautical propulsion unit (10) according to claim 48, wherein the ratio C/E is less than 1 at the radially outer ends (25) of two rotor or stator blades which are adjacent around the longitudinal axis (X).

50. The aeronautical propulsion unit according to claim 42, wherein:
said respective reference axes of the stator blades are arranged in one or more stator rows, each perpendicular to the longitudinal axis (X), each comprising several stator blades,
with Reₛ corresponding to a maximum radius of a stator blade measured relative to the longitudinal axis (X), said maximum radius is defined for each stator row as follows: (Re_{s,j})_{1≤j≤N}, where Re_{s,1}, Re_{s,2}, Re_{s,3} . . . correspond to a maximum radii of the blades of each stator row, with
$$0 \leq \frac{{max}_{j} \{ R {e}_{s , j} \} - {min}_{k} \{ R {e}_{s , k} \}}{R {e}_{h} - R {i}_{h}} \leq 0.3 ,$$
or preferably:
$$0.01 \leq \frac{{max}_{j} \{ R {e}_{s , j} \} - {min}_{k} \{ R {e}_{s , k} \}}{R {e}_{h} - R {i}_{h}} \leq 0 \text{.2} ,$$
and j=1, . . . , N and k=1, . . . , N when j≠k, N being a natural number defining the number of rows of stator blades.

51. The aeronautical propulsion unit according to claim 50, wherein:
said respective reference axes of the stator blades are arranged in several stator rows, each perpendicular to the longitudinal axis (X), each comprising several stator blades,
with Reₛ corresponding to the maximum radius of a stator row blade measured relative to the longitudinal axis (X):
said maximum radius is defined for each stator row as follows: (Re_{s,j})_{1≤j≤N}, where Re_{s,1}, Re_{s,2}, Re_{s,3} . . . correspond to the maximum radii of the blades of each stator row, N being a natural number defining the number of rows of stator blades,
all the radii of the blades of the same stator row are identical, and
Re_{s,1}≥Re_{s,2}≥Re_{s,3}≥ . . . , meaning that the maximum radii of the blades of the stator rows decrease in the downstream direction.

52. A propulsion assembly for an aircraft, comprising:
the aeronautical propulsion unit (10) according to claim 34,
an engine casing (13) around which the stator blades (18) are arranged, and
an attachment structure (27) for fixing the aeronautical propulsion unit (10) to the aircraft, the attachment structure (27) having, or defining, when viewed in a plane (P1) perpendicular to said longitudinal axis (X) and at least partially intersecting one of the stator blades, a protuberance (36) extending between two stator blades or axially adjacent to them,
the assembly being such that:
around the longitudinal axis (X), an angular position at 12 o'clock is defined as positioned vertically upwards relative to the longitudinal axis (X) and an angular position at 6 o'clock as positioned vertically downwards relative to the longitudinal axis (X), and
at least some of the stator blades are axially distributed according to a linear law such that, among these blades, the blade closest to 12 o'clock is the one furthest upstream of said blades along the longitudinal axis (X) and the one at 6 o'clock is the one furthest downstream along the longitudinal axis (X).

53. An aircraft having a longitudinal axis (X1) and comprising:
the aeronautical propulsion unit (10) according to claim 34,
a fuselage (33) and
a wing (31) to which the aeronautical propulsion unit (10) is fixed,
wherein the absolute value of the angle (∥β⊕) between the longitudinal axis (X) of the aeronautical propulsion unit and the longitudinal axis of the aircraft (X1) varies between 0.5° and 30°, preferably between 2° and 20°, or more preferably between 3° and 10°.
